(19) United States
(12) Patent Application Publication
(10) Pub. No.: US 2017/0161648 A1
(43) Pub. Date: Jun. 8, 2017

(54) Lodging Room Price Optimization

(71) Applicant: Roomer Travel LTD., Tel-Aviv (IL)

(72) Inventors: Gon Ben David, Givat Ela (IL); Vitali Margolin, Ashdod (IL); Shachar Parizer, Lod (IL)

(73) Assignee: Roomer Travel Ltd., Tel-Aviv (IL)

(21) Appl. No.: 15/327,114

(22) PCT Filed: Jul. 2, 2015
(86) PCT No.: PCT/IB2015/054983

§ 371 Date: Jan. 18, 2017

Related U.S. Application Data
(60) Provisional application No. 62/041,158, filed on Aug. 25, 2014.

(51) Int. Cl. G06Q 10/02

(52) U.S. Cl. CPC G06Q 10/02

(57) ABSTRACT

A room price optimization method, comprising receiving by a system server at least one room offer request for a plurality of nights from a user; splitting by the system server the at least one room offer request into a plurality of separate requests, sending by the system server the plurality of separate requests to each of at least two suppliers' systems, receiving by the system server from each of the at least two suppliers' systems an offer for each of the plurality of separate requests and finding a lowest price combination out of the plurality of separate offers to satisfy the room offer request.

### CROSS-REFERENCE TO RELATED PATENT APPLICATIONS

This patent application claims priority from and is related to U.S. Provisional Patent Application Ser. No. 62/041,158, filed 25 Aug. 2014, this U.S. Provisional Patent Application incorporated by reference in its entirety herein.

### FIELD OF THE INVENTION

The present invention generally relates to price optimization and specifically to a lodging room price optimization.

### BACKGROUND

Existing systems in the field of lodging room price optimization receive users' requests containing requested dates for a room. According to these dates, systems often try to find the supplier who offers the best deal for those dates and present his and all the other suppliers offers in a table.

None of the existing systems optimize each room's price by splitting the user's request into a number of separate requests in order to find the best suppliers combination that provides a better price for each room.

Therefore, there is a long felt need for a lodging room price optimization system which splits a request for a room for certain dates into a number of requests in order to find the optimal suppliers combination that leads to the cheapest price for a certain room.

### SUMMARY

According to an aspect of the present invention there is provided a room price optimization system, comprising a system server comprising at least one data base of room names and types, a plurality of suppliers' systems connected with the system server and a plurality of users' electronic communication devices communicating with the system server; wherein the system server is configured to split at least one room offer request for a plurality of nights received from at least one of the plurality of users into a plurality of separate requests, send the plurality of separate requests to each of at least two of the plurality of suppliers' systems, receive an offer for each of the plurality of separate requests from each of the at least two suppliers' systems and find a lowest price combination out of the plurality of separate offers to satisfy the room offer request.

The suppliers may comprise at least one of travel agencies, agents and combination thereof.

The number of the plurality of separate requests for N nights may be (N+1)*2^{(N-2)}.

The number of the plurality of separate requests for N nights may be N*(N+1)/2.

The room price optimization system may further be configured to order the lowest price combination from the suppliers, receive an order number for each request in the combination and merge the order numbers into a single order number.

According to another aspect of the present invention there is provided a room price optimization method, comprising receiving by a system server at least one room offer request for a plurality of nights from a user, splitting by the system server the at least one room offer request into a plurality of separate requests, sending by the system server the plurality of separate requests to each of at least two suppliers' systems, receiving by the system server from each of the at least two suppliers' systems an offer for each of the plurality of separate requests and finding a lowest price combination out of the plurality of separate offers to satisfy the room offer request.

The suppliers may comprise at least one of travel agencies, agents and combination thereof.

The number of the plurality of separate requests for N nights may be (N+1)*2^{(N-2)}.

The number of the plurality of separate requests for N nights may be N*(N+1)/2.

The room price optimization method may further comprise the steps of ordering the lowest price combination from the suppliers, receiving an order number for each request in the combination and merging the orders numbers into a single order number.

### BRIEF DESCRIPTION OF THE DRAWINGS

For better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 is a schematic block diagram of the system according to embodiments of the present invention;

FIG. 2 is a flowchart showing an exemplary process of finding the optimal room price according to a user's request;

FIG. 3 shows an exemplary table comprising the room price of a supplier (supplier 1) for each request;

FIG. 4 shows another exemplary table comprising the room price of a different supplier (supplier 2) for each request;

FIG. 5 shows an exemplary table, built by the system of the present invention and comprising the cheapest room price received from the various suppliers for each request while the number of requests is determined by formula (1);

FIG. 6 shows a table representing the number of requests according to the number of nights a user wishes to order as calculated by formula (1);

FIG. 7 shows an exemplary table, built by the system of the present invention and comprising the cheapest room price received from the various suppliers for each request while the number of requests is determined by formula (2);

FIG. 8 shows a table representing the number of requests according to the number of nights a user wishes to order as calculated by formula (2);

FIG. 9 is a flowchart showing a purchasing process which may be performed as the user receives the optimal price from the system of the present invention;

FIG. 10 demonstrates a way to combine the separate orders into a single order according to exemplary embodiments of the invention; and

FIG. 11 demonstrates another way to combine the separate orders into a single order according to exemplary embodiments of the invention.

### DETAILED DESCRIPTION OF PREFERRED EMBODIMENTS

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

The present invention provides a lodging room price optimization system and method. The system receives from users requests for a room for certain dates and finds the optimal suppliers' combination in order to provide the optimal price for each room in those requested dates.

A supplier as used herein is defined as any entity which mediates between users seeking rooms and room providers such as hotels etc. For example travel agencies, agents, etc.

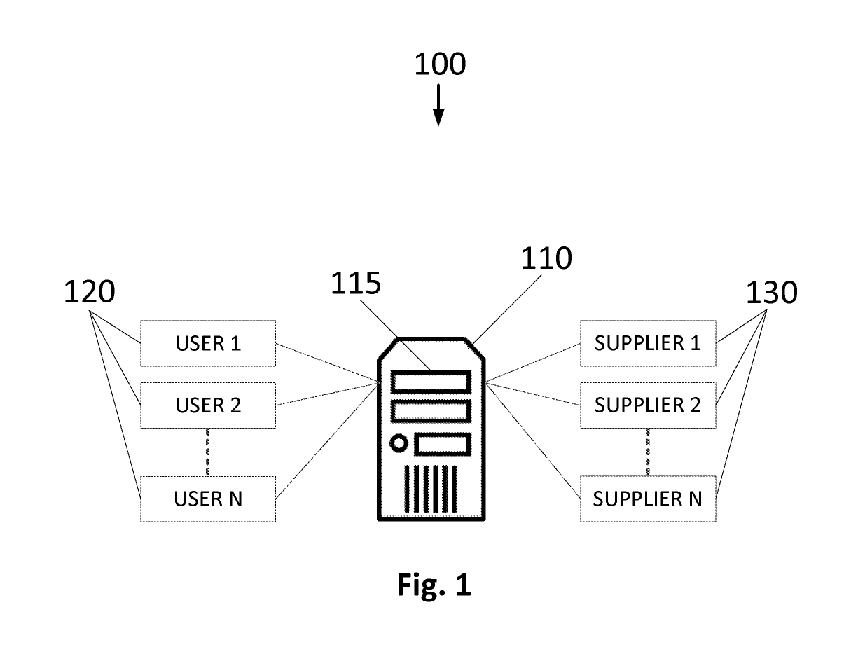

FIG. 1 is a schematic block diagram of the system 100 according to embodiments of the present invention comprising: a system server 110 comprising a database 115 of room types, names, photos, etc. The system server 110 is connected with a plurality of users 120 via a designated web site and with a plurality of suppliers 130.

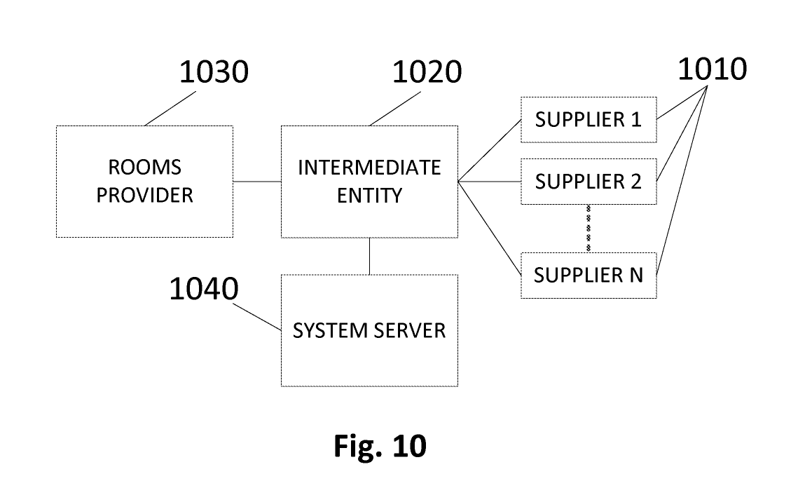

According to embodiments of the present invention, the system server 110 may also be connected to room providers (e.g. hotel) and/or intermediate entities as will be explained below in conjunction with FIGS. 9 and 10. The intermediate entities are also connected to the room providers.

Different suppliers may call the same room by different names. For example, one may call the room “Superior room” and the other may call it “King room”. The system normalizes each room's names to one name in order to present a single name to the users.

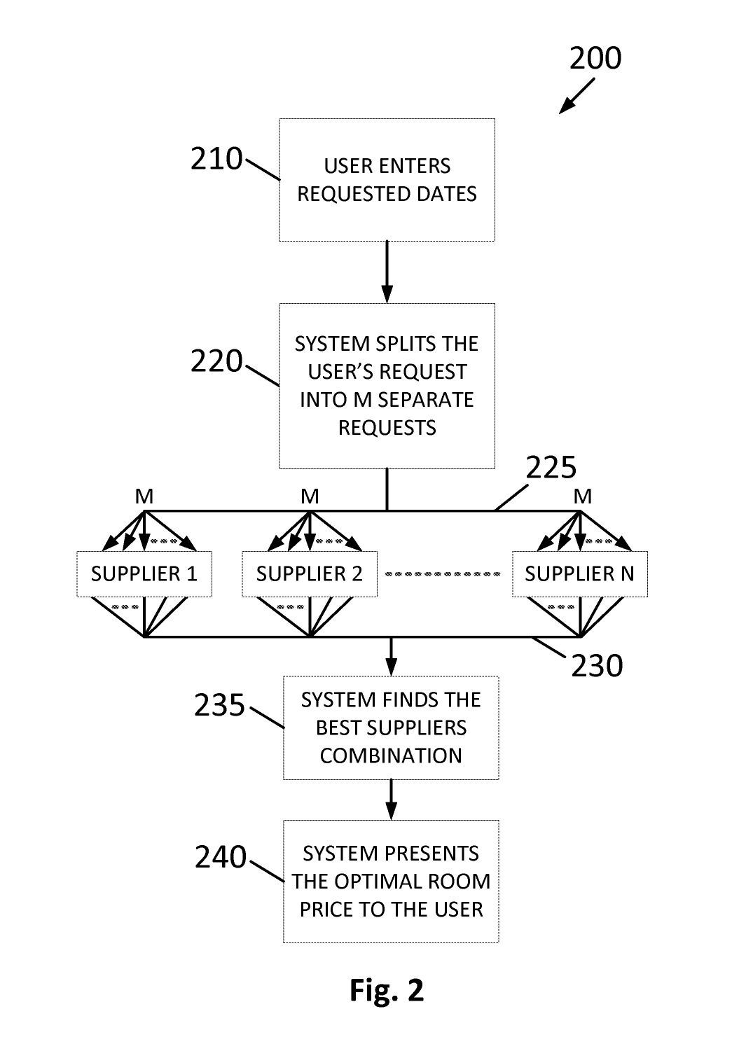

FIG. 2 is a flowchart 200 showing an exemplary process of finding an optimal room price according to a user's request. According to embodiments of the invention, in step 210, the user enters the requested dates, for example 1.12.14-4.12.14 (three nights). In step 220, the system splits the user's request into separate requests (M). The M requests are related to a certain room and the number of separate requests may be determined by formula (1) or formula (2) presented below. In step 225, the M separate requests are sent to each supplier. In step 230, the system receives the various offers for each request from the different suppliers. In step 235, the system finds the suppliers that offer the cheapest price for each request. The combination of the cheapest offers provides the optimal room price. In step 240 the system presents the optimal room price to the user.

According to embodiments of the invention, the process of FIG. 2 may be performed unlimited number of times in order to provide a list of different rooms with optimized prices.

It will be appreciated that any number of nights for any date may be searched.

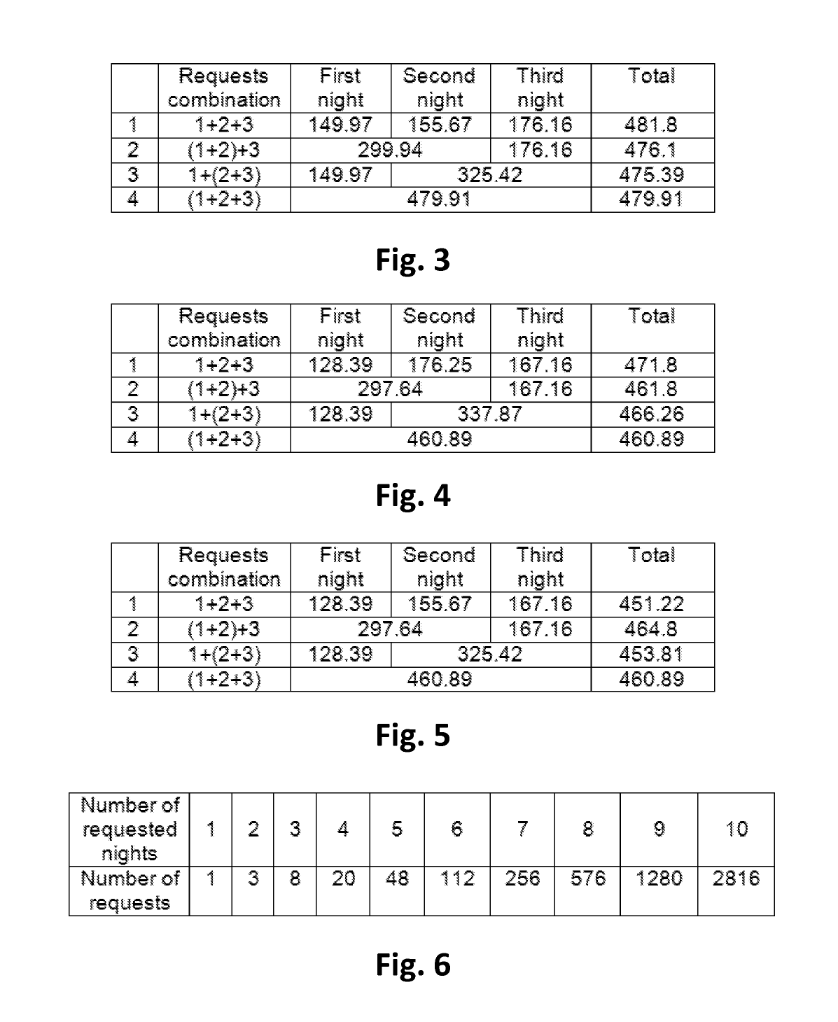

Examples of requests, for the example of three nights, are presented in FIGS. 3 and 4.

Each of these requests may be sent to the various suppliers connected with the system server.

FIG. 3 shows an exemplary table comprising the room price of a supplier (supplier 1) for each request out of the M requests. The first line represents three separate requests, one for each night. The second line represents two separate requests, one for the first and second nights and the other for the third night. The third line represents two separate requests, one for the first night and the other for the second and third nights. The fourth line represents one request for the three nights.

All in all, the number of requests is 8 (M=8).

FIG. 4 shows another exemplary table comprising the room price of a different supplier (supplier 2) for each request out of the M requests. The first line represents three separate requests, one for each night. The second line represents two separate requests, one for the first and second nights and the other for the third night. The third line represents two separate requests, one for the first night and the other for the second and third nights. The fourth line represents one request for the three nights.

All in all, the number of requests is 8 (M=8).

FIG. 5 shows an exemplary table, built by the system of the present invention and comprising the cheapest room price received from the various suppliers for each request. The first line represents the cheapest price for each night. The second line represents the cheapest price for the first and second nights and the cheapest price for the third night. The third line represents the cheapest price for the first night and the cheapest price for the second and third nights. The fourth line represents the cheapest price for the three nights.

As can be seen in the tables of FIGS. 3-5, the cheapest total price offered by supplier 1 is 475.39, the cheapest total price offered by supplier 2 is 460.89 and the cheapest total price offered by the system of the present invention is 451.22.

According to embodiments of the invention, the number of separate requests (M) may be calculated according to the number of nights a user wishes to order by the following formula:

Number of separate requests=M=(N+1)*2^{(N-2)} (1)

Where N=the number of nights a user wishes to order.

FIG. 6 shows a table representing the number of separate requests (M) according to the number of nights a user wishes to order as calculated by formula (1).

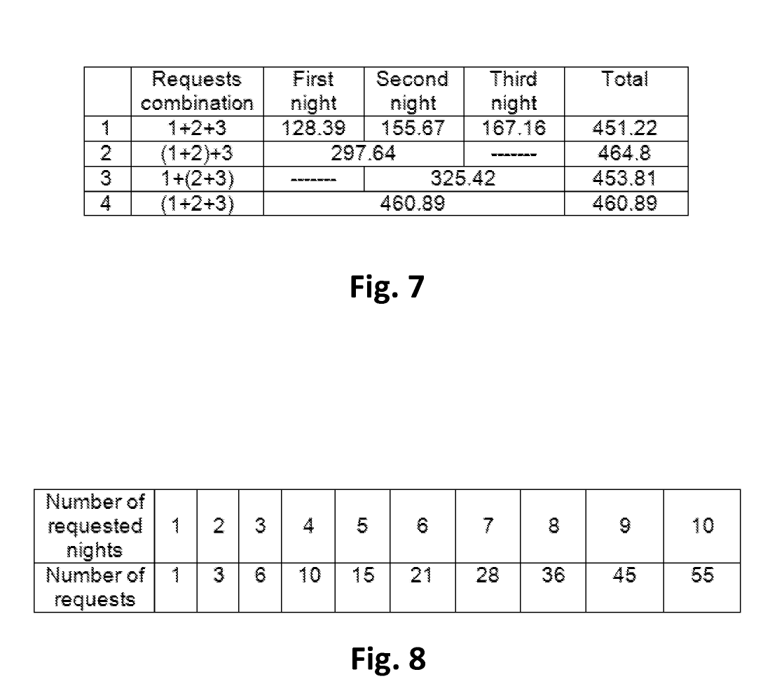

The problem with formula (1) is that it produces many separate requests to be sent to the different suppliers. For example, as can be seen in FIG. 6, the total number of requests for 4+ nights is not feasible. Therefore, the present invention offers to reduce the total number of separate requests by saving the result of each request. By saving the results the system may skip a request that was already requested. For example, as can be seen in the exemplary table of FIG. 7, the request for the third night's price, in the second line, may be skipped because the system already has the price of this night from line 1. Similarly, the request for the first night's price, in the third line, may be skipped because the system already has the price of this night from line 1.

Therefore, the new formula may be the following formula:

Number of separate requests=M=N*(N+1)/2 (2)

Where N=the number of nights a user wishes to order.

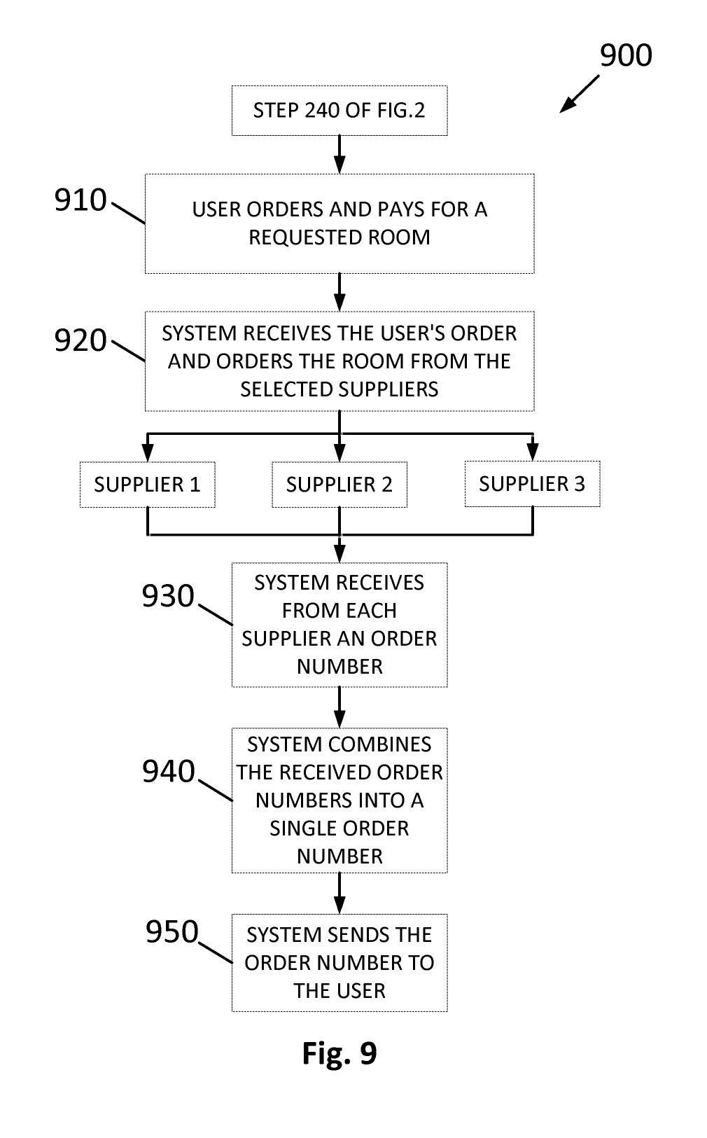

FIG. 8 shows a table representing the number of separate requests (M) according to the number of nights a user wishes to order as calculated by formula (2).

FIG. 9 is a flowchart 900 showing a purchasing process which may be performed as the user receives the optimal price from the system of the present invention (step 240 of FIG. 2). In step 910 the user orders and pays for a requested room. In step 920, the system receives the user's order and orders the room from the selected suppliers (e.g. three suppliers). In step 930, the system receives from each supplier an order number. In step 940 the system combines the received order numbers into a single order number (according to the process described in conjunction with FIGS. 10 and/or 11). In step 950 the system sends the order number to the user.

As mentioned above, after the user has received the optimal price and purchased the deal, the system has to make sure that the separate orders from the different suppliers are combined into a single order.

FIG. 10 demonstrates a way to combine the separate orders into a single order according to exemplary embodiments of the invention. In order to forward each supplier's order to the room provider 1030 (e.g. hotel), suppliers 1010 may use an intermediate entity 1020. In order to make sure that the separate orders from the different suppliers are combined into a single order, the present invention's server 1040 (server 110 of FIG. 1), may communicate with the intermediate entity 1020 and instruct it to combine the separate orders into a single order with a single order number to be forwarded to the user.

For example, a user purchased a three nights deal for a certain room. In practice, this deal is a combination of, for example, three different orders from three different suppliers. The system receives the three orders numbers from the three suppliers and asks the intermediate entity to combine these three orders into a single order with a single order number, hence when the user will arrive at the room provider (e.g. hotel) he will have one order and not three separate ones.

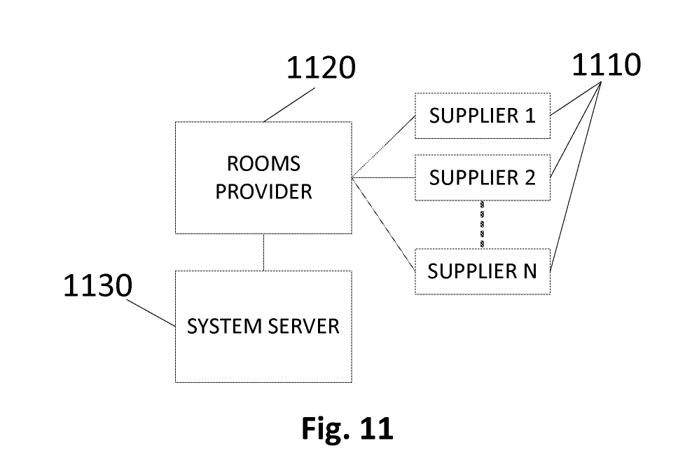

FIG. 11 demonstrates another way to combine the separate orders into a single order according to exemplary embodiments of the invention. In order to forward each supplier's order to the room provider 1120 (e.g. hotel), suppliers 1110 may communicate with the room provider 1120 directly. In order to make sure that the separate orders from the different suppliers are combined into a single order with a single order number, the present invention's server 1130 (server 110 of FIG. 1), may communicate with the room provider 1120 in order to combine the separate orders into a single order. The single order number may be for example the order number of the first night's order. Alternatively, the single order number may be a new order number.

In a case where some of the suppliers communicate with the room provider through an intermediate entity and some communicate with the room provider directly, the present invention's server (server 110 of FIG. 1), may communicate with the room provider in order to combine the separate orders into a single order.

It will be appreciated that the room provider is not limited to hotel and may also include motel, hostel, lodging, inn, guest room, guest house or any other provider that supplies rooms.

It will be appreciated by persons skilled in the art that the present invention is not limited to what has been particularly shown and described hereinabove. Rather the scope of the present invention is defined by the appended claims and includes combinations and sub-combinations of the various features described hereinabove as well as variations and modifications thereof which would occur to persons skilled in the art upon reading the foregoing description.

I claim:

1. A room price optimization system, comprising:
a system server comprising at least one data base of room names and types;
a plurality of suppliers' systems connected with said system server; and
a plurality of users' electronic communication devices communicating with said system server,
wherein said system server is configured to split at least one room offer request for a plurality of nights received from at least one of said plurality of users into a plurality of separate requests, send said plurality of separate requests to each of at least two of said plurality of suppliers' systems, receive an offer for each of said plurality of separate requests from each of said at least two suppliers' systems and find a lowest price combination out of said plurality of separate offers to satisfy said room offer request.

2. The room price optimization system of claim 1, wherein said suppliers comprise at least one of travel agencies, agents and combination thereof.

3. The room price optimization system of claim 1, wherein the number of said plurality of separate requests for N nights is (N+1)*2^{(N-2)}.

4. The room price optimization system of claim 1, wherein the number of said plurality of separate requests for N nights is N*(N+1)/2.

5. The room price optimization system of claim 1, further configured to order said lowest price combination from said suppliers, receive an order number for each request in said combination and merge said order numbers into a single order number.

6. A room price optimization method, comprising:
receiving by a system server at least one room offer request for a plurality of nights from a user;
splitting by said system server said at least one room offer request into a plurality of separate requests;
sending by said system server said plurality of separate requests to each of at least two suppliers' systems;
receiving by said system server from each of said at least two suppliers' systems an offer for each of said plurality of separate requests; and
finding a lowest price combination out of said plurality of separate offers to satisfy said room offer request.

7. The room price optimization method of claim 6, wherein said suppliers comprise at least one of travel agencies, agents and combination thereof.

8. The room price optimization method of claim 6, wherein the number of said plurality of separate requests for N nights is (N+1)*2^{(N-2)}.

9. The room price optimization method of claim 6, wherein the number of said plurality of separate requests for N nights is N*(N+1)/2.

10. The room price optimization method of claim 6, further comprising the steps of ordering said lowest price combination from said suppliers, receiving an order number for each request in said combination and merging said orders numbers into a single order number.
